(19) United States
(12) Patent Application Publication
(10) Pub. No.: US 2002/0018920 A1
(43) Pub. Date: Feb. 14, 2002

(54) Magnetic recording medium and magnetic recording apparatus

(75) Inventors: Tomoo Yamamoto, Hachioji (JP); Ichiro Tamai, Hachioji (JP); Kiwamu Tanahashi, Kokubunji (JP); Akira Ishikawa, Kokubunji (JP)

Correspondence Address: John C. Altmiller, Kenyon & Kenyon, 1500 K Street, N.W., Suite 700, Washington, DC, 20005, US

(73) Assignee: Hitachi, Ltd., Tokyo (JP)

(21) Appl. No.: 09/862,452

(22) Filed: May 23, 2001

(30) Foreign Application Priority Data
May 26, 2000 (JP) 2000-161122

(51) Int. Cl. G11B 5/73

(52) U.S. Cl. 428/694 TS

(57) ABSTRACT

A magnetic recording apparatus of a large capacity capable of super-high density recording of 10 Gbits or more per one square inch has a magnetic recording medium prepared by forming a Co alloy magnetic layer by way of an underlayer comprising Co or Cr alloy on a substrate, in which an amorphous or micro crystal seed layer containing at least Ti and Al is disposed between the substrate and the underlayer, the magnetic layer has an h.c.p. structure and is grown to (1.1.0) direction parallel with the substrate, the magnetic recording medium of high coercivity and reduced noises and undergoing less effects of thermal fluctuation being provided because of in-plane orientation of the axis of easy magnetization of the magnetic layer and the reduced size of the magnetic crystal grains and dispersion thereof, combination of the magnetic recording medium and the magnetic head having a read only device utilizing the magnetoresistive effect capable of providing a magnetic recording apparatus having a recording density at 10 Gbits or more per one square inch.

### BACKGROUND OF THE INVENTION

1. Field of the Invention

This invention concerns a magnetic recording medium such as a magnetic drum, a magnetic tape, a magnetic disk and a magnetic card, as well as a magnetic recording apparatus and, more in particular, it relates to an in-plane magnetic recording medium suitable to super-high density recording of 10 Gbits or more per one square inch and a magnetic recording apparatus using the magnetic recording medium described above.

2. Description of the Related Prior Art

In recent years a demand has been increased more for hard disk drives with an aim of mounting on a notebook-sized personal computer. Since it is a basic premise that the notebook-sized personal computer is portable, a hard disk is required to have excellent impact resistance. Further, for a hard disk drive mounted on a disk array system, it has now been required to rotate a magnetic recording medium at a higher speed than usual with an aim of high speed transfer of data. For the media in any of the application uses, it has become essential to use a substrate having high rigidity, that is, a substrate made of ceramics such as glass. What is most important in the use of the glass substrate is a development for a seed layer disposed just on the substrate. Generally, for attaining a high density recording in the in-plane recording medium, it is considered effective to orient the axis of easy magnetization within a plane of film. Usually, a magnetic layer is constituted with a polycrystal material and the crystallographic structure is a hexagonal closed-packed (h.c.p) structure. For in-plane orientation of the axis of easy magnetization, that is, in-plane orientation of the c axis of the h.c.p. structure, used is a method of forming an underlayer having a body centered cubic structure before forming the magnetic layer. When the underlayer having the b.c.c. structure is oriented in (100) or (211) direction and a magnetic layer is formed on the underlayer by utilizing epitaxial growing technology, the magnetic layer is oriented in (11.0) or (10.0) direction and the axis of easy magnetization is directed within the plane of film.

In an Al alloy substrate applied with Ni-P plating used generally so far, it is extremely easy for (100) orientation of a Cr underlayer having a b.c.c. structure and in-plane orientation of the axis of easy magnetization of the magnetic layer. On the other hand, in the glass substrate, it is difficult for the control of crystallographic orientation since there are a lot of (110) oriented components when the underlayer is merely formed directly on the substrate. In view of the above, for (100) or (211) orientation of the underlayer, in the glass substrate, it has been proposed to further dispose a seed layer on the glass substrate. As the material for the seed layer, use of CoCrZr has been reported for example (IEEE Trans. Magn. 35, pp. 2640-2642, September 1999). According to this report, a CrTi underlayer disposed on CoCrZr is oriented in (100) direction and, further, a magnetic layer on the underlayer is oriented in (11.0) orientation. Further, it has also been reported that a magnetic layer is oriented in (10.0) direction when using a seed layer NiAl having a B2 structure (IEEE Trans. Magn. 30, pp. 3951-3953, November 1994). While directions of crystal growth of the magnetic layers are different, they have succeeded in the in-plane orientation of the axis of easy magnetization in each case.

### BRIEF SUMMARY OF THE INVENTION

In recent years, the size of recording bits formed on magnetic recording media has gradually been decreased along with remarkable increase in the capacity and recording density in magnetic disk apparatus. For attaining super-high density recording of 10 Gbits of more per one square inch, it is difficult to cope with such situation with existent media and medium noises have to be reduced further. For this purpose, it is important to decrease the crystal grain size of the magnetic layer. However, when the volume of magnetic grains is decreased extremely by refinement of magnetic crystal grains, effect of thermal energy becomes conspicuous relatively even under a normal temperature to decay recording magnetization. This phenomenon is generally referred to as thermal fluctuation in magnetization. According to Y. Hosoe, et al, it was reported that information recorded at a density of 225 kFCI is decayed by as much as 10% or more after 96 hours in a medium that attained the reduced noises by the refinement of crystal grains (IEEE Trans. Magn. 33. pp. 3028-3030, September 1997). In view of the basic application uses of magnetic recording media of preserving information, this is an important problem (defect) and this subject has to be overcome soon.

For making the reduction of noises and the improvement of the thermal fluctuation resistance of the medium compatible, it is effective to decrease the average size of the crystal grains of the magnetic layer and, at the same time, suppress the growth of extremely small magnetic grains. That is, it is important to decrease the dispersion in the size of the magnetic crystal grains. Since the magnetic layer is hetero epitaxially grown on the underlayer, control for the crystal grain size or dispersion thereof of the magnetic layer is naturally conducted by controlling the grain size and the dispersion thereof of the underlayer. Further, in a medium using a glass substrate, a seed layer is disposed between the substrate and the underlayer as has been described above for the related art. Accordingly, the material and the deposition method for the seed layer are important in controlling the crystal grains of the underlayer. Further, since it is necessary in the in-plane recording medium to orient the axis of easy magnetization of the magnetic layer within the plane of film, it is important to provide the seed layer with a function of controlling the crystallographic orientation of the underlayer simultaneously.

This invention intends at first to develop a new seed layer for increasing the crystallographic orientation of the axis of easy magnetization in the direction within the plane of film and controlling the size of the magnetic crystal grains and the dispersion thereof, thereby providing an in-plane magnetic recording medium having both reduced noises and thermal fluctuation resistance.

Secondly, this invention intends to provide a magnetic recording apparatus fully taking the advantageous performance of the magnetic recording medium and having a recording density of 10 Gbits or more per one square inch.

For the recording media including a magnetic layer, an underlayer and a substrate, the subject of this invention described above can be attained by forming a seed layer containing at least Ti and Al between the substrate and the underlayer in the magnetic recording media

The seed layer preferably contains at least 35 at % or more and 65 at % or less of Ti and 35 at % or more and 65 at % or less of Al, for the in-plane orientation of the axis of easy magnetization of the magnetic layer.

According to our study conducted for this invention, it has been found that the crystal structure of the seed layer preferably comprises amorphous or microcrystals with a crystal grain size of 10 nm or less.

The crystal structure of the seed layer as described above is attained in that the material composition of the seed layer contains at least 35 at % or more and 65 at % or less of Ti and 35 at % or more and 65 at % or less of Al.

Generally, in Ti—Al alloy bulk materials, a regular phase having an L1₀ crystal structure is formed in a compositional region at Ti:Al element ratio of about 1:1. However, when a thin film is prepared by sputtering at Ti:Al=1:1 composition, it has been found that there are film deposition conditions not causing crystallization depending on the substrate temperature. When the surface of the thus prepared TiAl seed layer is subjected to an oxidizing or nitriding treatment and then an underlayer having the b.c.c. structure comprising Cr or Cr alloy on the TiAl seed layer, a satisfactory (100) orientation was obtained. Further, when a Co alloy magnetic layer having the h.c.p. structure is formed on the underlayer, the axis of easy magnetization is strongly oriented within the plane of film. As a concrete method of oxidizing or nitriding the TiAl surface, it is effective to adopt a method such as exposure in oxygen atmosphere or a nitriding atmosphere. Exposure to the oxygen atmosphere or nitriding atmosphere means introduction of an oxygen gas or nitrogen gas into a vacuum vessel (oxygen blow or nitrogen blow) upon forming the sputtering. Further, similar effect can also be obtained by exposing TiAl after formation to the atmospheric air. For example, TiAl may be formed in a separate apparatus (place) and then the underlayer and subsequent layers can be formed on the underlayer as a substrate in one identical apparatus. When the method is compared with the Ni—P plated Al alloy substrate, the Al base metal corresponds to glass and Ni—P corresponds to TiAl, respectively.

### BRIEF DESCRIPTION OF THE SEVERAL VIEW OF THE DRAWINGS

FIG. 1 is a schematic cross sectional view of an example of a magnetic recording medium according to this invention;

FIG. 2 is a view showing the dependence of the crystallographic orientation on the substrate temperature in a magnetic recording medium according to this invention;

FIG. 3 is a view showing the dependence of the crystallographic orientation on the substrate temperature and the seed layer heating temperature in a magnetic recording medium according to this invention;

FIG. 4 is a graph illustrating the difference of crystallographic orientation between the magnetic recording medium according to this invention and an existent medium;

FIG. 5 is a graph illustrating the difference of magnetic characteristics between the magnetic recording medium according to this invention and an existent medium;

FIG. 6 is a view showing the dependence of the crystallographic orientation on the substrate temperature and the seed layer heating temperature in a magnetic recording medium according to this invention;

FIG. 7 is a view showing the dependence of the crystallographic orientation on the substrate temperature and the seed layer heating temperature in a magnetic recording medium according to this invention;

FIG. 8 is a view showing the dependence of the crystallographic orientation on the substrate temperature and the seed layer heating temperature in a magnetic recording medium according to this invention;

FIG. 9 is a structural view illustrating one example of a magnetic head having a read only device;

FIG. 10 is a structural view illustrating one example of a magnetoresistive sensor;

FIG. 11 is a structural view illustrating one example of a spin valve type magnetoresistive sensor; and

FIG. 12 is a schematic view illustrating one example of a structure of a magnetic recording apparatus.

### DETAILED DESCRIPTION OF THE INVENTION

### Example 1

A medium using a TiAl seed layer according to this invention and an existent medium of using a CoCrZr seed layer were compared. In each of the CoCrZr seed layer and the TiAl seed layer, a fine layer structure comprises micro crystal with a crystal grain size of 10 nm or amorphous. In the medium using the TiAl seed layer, the axis of easy magnetization is oriented within the plane of film by (100) orientation of the underlayer and (11.0) orientation of the magnetic layer. However, it was found that the degree of the crystallographic orientation is stronger in the case of using the TiAl seed layer. Further, the magnetic crystal grains of the media were examined by using a transmission electron microscope (TEM). The average magnetic crystal grain size was 10 nm in the case of using the TiAl seed layer and 15 nm in the case of the CoCrZr seed layer. It was found that smaller crystal grain size is preferred for reducing the medium noises and the TiAl seed layer was excellent. On the other hand, as a countermeasure for the thermal fluctuation, it is preferred that the dispersion of the crystal grain size of the magnetic layer (defined as a value obtained by dividing the standard deviation with an average grain size). The value was 25% in the TiAl seed layer and 35% in the CoCrZr seed layer. Also in this regard, it was found that the TiAl seed layer was more excellent.

Further, the medium using the TiAl seed layer according to this invention was compared also with an existent medium using an NiAl seed layer. The medium using the NiAl seed layer is of a type in which the axis of easy magnetization is oriented within the plane of film by (211) orientation of the underlayer and (10.0) orientation of the magnetic layer and the process of the crystal growing is different from the case of using the TiAl seed layer according to this invention. Further, the NiAl seed layer is a completely crystalline layer having a B2 type structure and is different also in the crystal structure of the layer from the TiAl seed layer which is amorphous or micro crystal. According to our study, the defect of the NiAl seed layer is that the layer thickness has to be increased to 50 nm or more, which causes a problem for the manufacture of the medium.

The layer thickness has to be increased by the reasons described below. When the NiAl film is formed by sputtering, the preferred orientation plane is closed-packed plane (110) in the initial stage of the crystal growth. However, the preferred orientation plane gradually changes to (211) in the course of the crystal growth. When an underlayer having the b.c.c. structure is epitaxially grown thereon, the underlayer is oriented in (211) direction and the magnetic layer thereon is oriented in (10.0) direction. That is, it is important that (211) orientation is obtained in the NiAl seed layer for (10.0) orientation of the magnetic layer. For this purpose, it is necessary to increase the thickness of the NiAl seed layer to the layer thickness of about 50 nm where (211) is the preferred orientation plane. Further, since the crystallographic orientation of the magnetic layer is controlled by way of such a complicate growing process, it is difficult to strongly orient the axis of easy magnetization within the plane of film. That is, it is difficult for the complete (211) orientation of the NiAl seed layer. Actually, in a medium of using the NiAl seed layer, the intensity for (10.0) component of the magnetic layer is weak. When the magnetic characteristics of the medium using the TiAl seed layer according to this invention and the medium of using the NiAl seed layer are compared, the coercivity (Hc) and the coercivity squareness (S*) are smaller in the medium using the NiAl seed layer. This is because the in-plane crystallographic orientation of axis of easy magnetization is relatively weak.

In the TiAl seed layer according to this invention, it is essential to contain at least 35 at % or more and 65 at % or less of Ti and 35 at % or more and 65 at % or less of Al and, on the other hand, other elements can be added by 30 at % or less. When other elements are added by 30 at % or more, it is not preferred since the crystal structure itself of the seed layer is changed. A principal reason for adding other elements is to further facilitate the control of the microstructure of the seed layer.

As has been explained previously, it is important that the seed layer comprises micro crystal with a crystal grain size of 10 nm or less, or amorphous. In this invention, the microstructure is controlled by the film deposition conditions such as the substrate temperature and the form can further be controlled easily by adding other elements. For example, when an element of higher melting point than Ti or Al or an element having a larger lattice constant is added, the crystal grains tend to be refined or become amorphous more easily.

Further, another reason of adding other element in the seed layer according to this invention is an improvement for the reliability of a magnetic disk. Addition of other element to the TiAl seed layer can improve the hardness and can improve the resistance to a so-called head crush in which the surface of the disk is injured by the magnetic head when the magnetic head is followed for a long period of time at an identical radius.

There is no particular restriction on the kinds of other additive elements and it is important that the seed layer contains 35 at % or more and 65 at % or less of Ti and 35 at % or more and 65 at % or less of Al and the microstructure of the seed layer comprises a micro crystal of 10 nm or less, or amorphous.

Generally, elements such as Pt, Ta, Ti, Nb and B are added to the magnetic layer. In this case, since the lattice constant of the magnetic layer having the h.c.p. structure is made larger to deteriorate the lattice matching between the magnetic layer and the underlayer, it is necessary to make the lattice constant of the underlayer larger by alloying the layer. It is particularly preferred that the underlayer comprises Cr and 5 at % or more and 50 at % or less of Ti, Cr and 5 at % or more and 100 at % or less of Mo or Cr, Mo and Ti in order to increase the in-plane crystallographic orientation of the axis of easy magnetization of the magnetic layer. It is however important that the underlayer has a crystal structure of b.c.c. Use of the alloy containing Cr and Ti as the underlayer is preferred particularly in view of the reduction of noises since this can make the crystal grain size of the underlayer smaller and also make the crystal grain size of the magnetic layer grown thereon smaller. However, since Ti has the h.c.p. crystal structure in the Cr—Ti alloy, it is necessary that Ti in the composition of the underlayer is 50 at % or less based on the entire composition.

On the other hand, an alloy comprising Cr and Mo is in a complete solid solution in view of the phase diagram of the bulk metal and the crystal structure of the alloy is always b.c.c. structure, so that this is particularly preferred in view of easy handling for manufacturing crystals having an optional lattice space. The underlayer containing Cr, Mo and Ti has the properties of Cr—Mo, Cr—Ti described above in accordance with the concentration of the respective elements. When other elements than Cr, Mo and Ti are used for the underlayer, Nb, Ta or W is used preferably (however, the characteristics somewhat poor compared with Cr, Mo and Ti) and the use of other elements than described above is not preferred since this results in distortion of the crystallographic orientation, growing of the crystal grain size, to lower the coercivity or increase the medium noise.

The underlayer described above can be laminated by several layers or can be a dual layer structure comprising a first underlayer containing Cr or Cr Ti and a second underlayer containing at least one element selected from Cr, Nb, Mo, Ta, W and Ti in the order nearer to the substrate. When Cr is used for the first underlayer, (100) crystallographic orientation of the underlayer is more intense and, as a result, (100) orientation of the magnetic layer can be more strengthened to increase the coercivity. On the other hand, when CrTi is used for the first underlayer, the crystal grain size of the underlayer is made finer and, as a result, the crystal grains of the magnetic layer are also made finer, which is effective for reducing the noises.

The Co alloy magnetic layer preferably contains at least 15 at % or more and 25 at % or less of Cr and 4 at % or more and 25 at % or less of Pt for increasing the coercivity and reducing the noises of the medium. However, in the composition of the magnetic layer, at least Co has to be 56 at % or more. If the Co concentration is 56 at % or less, the residual magnetic fluxes density lowers remarkably and magnetic flux leaked from the medium are decreased making it difficult to read out signals by the magnetic head.

The magnetic layer described above is a multi-layered structure comprising at least two layers and the magnetic layer most remote from the substrate (magnetic layer at the uppermost surface) preferably contains at least one of elements selected from C, B, Si and Ta by 0.5 at % or more and 8 at % or less for attaining reduced noises and high coercivity.

C, B, Si and Ta as the additive elements to the magnetic layer have an effect of promoting segregation of Cr to the crystal grain boundary. According to the result of our study, it was found that the magnetic layer in which the Cr segregation is promoted causes less (11.0) orientation even on the underlayer having the b.c.c. structure oriented in (100) direction. This is considered that a Cr-rich layer is formed at the boundary between the magnetic layer and the underlayer, which hinders the epitaxial growing of the magnetic layer. On the other hand, it was found that epitaxial growing is attained on the crystal layer having the identical h.c.p. structure.

From the foregoing result, it led to a conclusion that a multi-layered structure of the magnetic layer is effective for controlling the crystallographic orientation of the magnetic layer with addition of the elements described above for the purpose of reducing the noises. That is, a magnetic layer not containing C, B, Si and Ta is disposed at first as a magnetic layer in contact with the underlayer to control the crystallographic orientation of the first magnetic layer to (110) direction. Then, when a second magnetic layer containing C, B, Si and Ta is disposed on the first magnetic layer, the second magnetic layer is grown epitaxially while reflecting the crystallographic orientation of the first magnetic layer as it is. This can control the axis of easy magnetization of the magnetic layer containing C, B, Si and Ta with an aim of reducing the noises within the plane of film and the performance can be utilized an utmost degree.

When a magnetic layer having the h.c.p. structure is epitaxially grown on an underlayer having the b.c.c. structure, since grains of different type of crystal structure are compulsorily grown, defects are introduced or fine magnetic crystal grains are formed at the initial stage of the crystal growing of the magnetic layer. Such the defect and the fine grains are highly sensitive to the effect of the thermal fluctuation and the decreasing ratio of the read out output with time is increased. For suppressing the effect as less as possible, an intermediate layer having a non-magnetic h.c.p. structure is preferably inserted between the underlayer and the magnetic layer. The non-magnetic h.c.p. intermediate layer absorbs the defects and fine grains formed at the boundary with the b.c.c. underlayer, to eliminate the undesired effects on the magnetic layer. Further, the non-magnetic h.c.p. intermediate layer can be applied to the dual magnetic layer medium described above such that the non-magnetic h.c.p. intermediate layer can be used as the first magnetic layer.

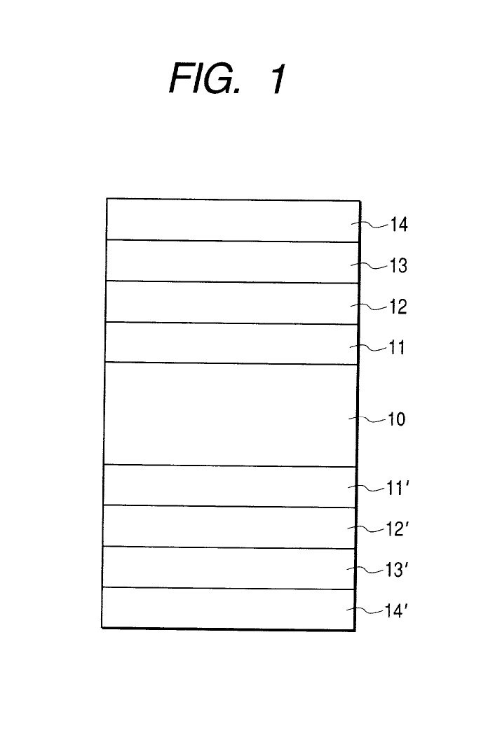

FIG. 1 shows a cross sectional view of an embodiment of a magnetic recording medium according to this invention. A basic layer constitution of a magnetic recording medium according to this invention is as described below.

TiAl seed layers 11, 11′ were formed each on a glass substrate 10 of 65 mmφ outer diameter. Then, underlayers 12, 12 each comprising a Cr alloy and Co-based alloy magnetic layers 13, 13′ were disposed. Finally, protective layers 14, 14′ each comprising C were formed and lubricants were coated to manufacture a magnetic recording medium according to this invention. In this embodiment, all of the layers were manufactured by a DC magnetron sputtering method. The basic sputtering conditions were at an Ar gas pressure of 0.27 Pa, and a density of input power of 39.5 kW/m².

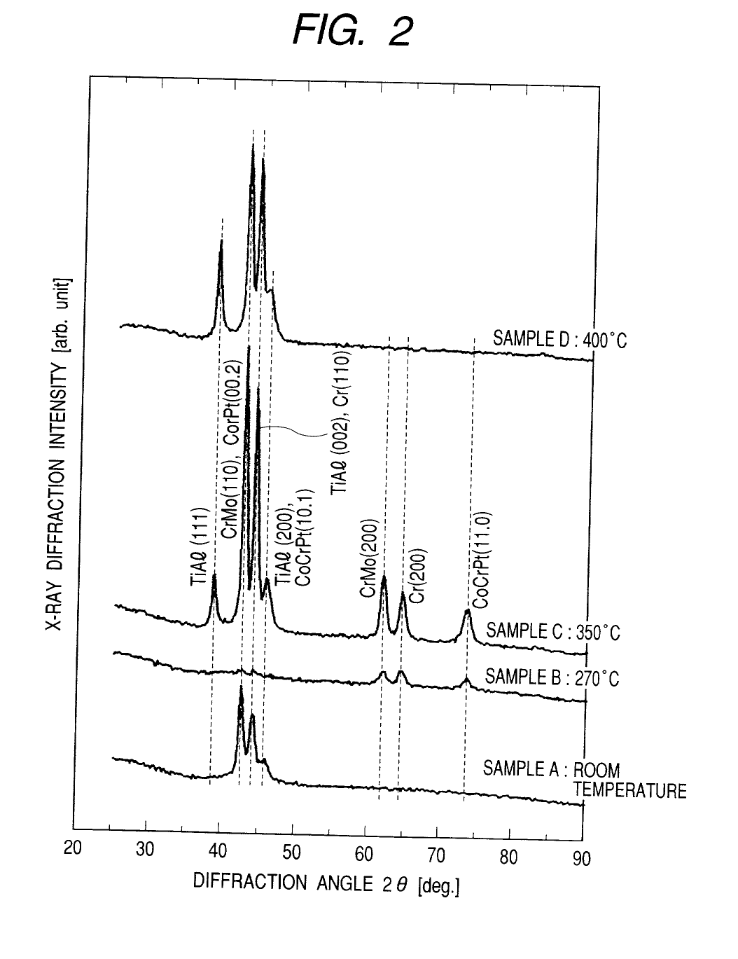

At first, FIG. 2 shows the result of X-ray analysis for the change of the crystallographic orientation of each layer depending on the substrate temperature of the medium according to this invention. The TiAl seed layer had a composition comprising Ti-52 at % Al (100 nm), and the underlayer had a dual underlayer structure prepared by laminating Cr-30 at % Mo (20 nm) after forming Cr (20 nm). The magnetic layer used had a composition of Co-20 at % Cr-10 at % Cr-10 at % Pt (14 nm). In the composition of the layers described above, a numerical appended before each element represents the concentration of the element by atomic percentage (at %) and the numerical in the parenthesis after the composition represents the layer thickness. The dependence on the substrate temperature examined here is a dependence on the temperature of the substrate heated by IR heater before forming TiAl. The heating time was 10 min.

In the specimen A where the substrate temperature was at a room temperature, diffraction peak from TiAl was not observed and diffraction peaks appeared for (110) in the Cr and CrMo underlayers and for (00.2), (10,1) in the CoCr Pt magnetic layer. That is, TaAl was amorphous or micro crystal and the axis of easy magnetization of the magnetic layer was oriented at random.

In the specimen B where the substrate was heated to 270° C., diffraction peak from TiAl was not observed like that in the case at the room temperature, and diffraction peaks were observed for (200) in the Cr and CrMo underlayers and for (110) in the CoCrPt magnetic layer, and it can be seen that the axis of easy magnetization of the magnetic layer was oriented within the plane of film. In the specimen C where the substrate was heated to 350° C., crystallization of TiAl was initiated and diffraction peaks appeared for (111), (002), (200) of TiAl and the crystallographic orientation of the Cr and CrMo underlayers and the CoCrPt magnetic layer were identical with those of the specimen B. However, since the diffraction intensity from the underlayer and the magnetic layer was increased compared with that of the specimen B, it may be a possibility that the crystallographic orientation was improved or the crystal grain size was increased.

Further, in the specimen D where the substrate was heated to 400° C., since the diffraction intensity for (111) of TiAl was increased, crystallization of TiAl proceeded further. Furthermore, since diffraction for (200) in the Cr and CrMo underlayers or for (11.0) in the CoCrPt magnetic layer was not observed, it can be seen that the axis of easy magnetization of the magnetic layer was not oriented within the plane of film. From the foregoing results, it is possible to orient the underlayer to (100) direction and the magnetic layer to (11.0) direction by elevating the substrate temperature while not completely crystallizing the TiAl seed layer but keeping the same in an amorphous or micro crystal state. That is, it has been found that the axis of easy magnetization can be oriented within the plane of film. Even when TiAl was somewhat crystallized as in the specimen C where the substrate was heated to 350° C., when the underlayer is oriented to (100) direction and the magnetic layer is oriented to (11.0) direction, a sufficient performance could be obtained as the in-plane magnetic recording medium since the axis of easy magnetization is directed within the plane of film. However, when the crystallization of TiAl proceeded remarkably as in the specimen D and orientation for (100) in the underlayer and for (11.0) in the magnetic layer was no more obtained, the coercivity was lowered undesirably.

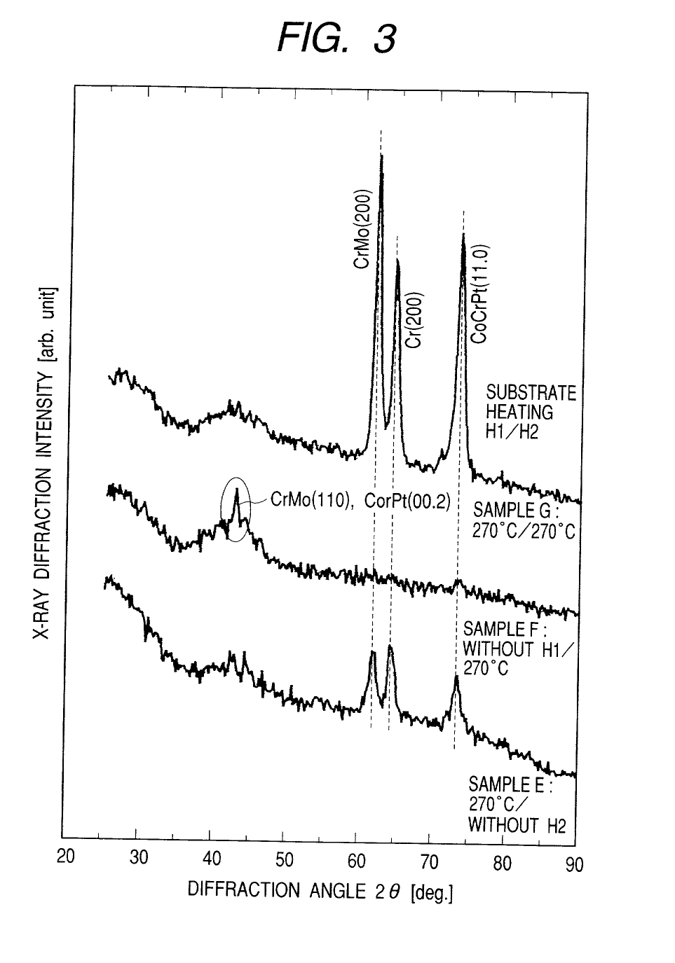

FIG. 3 shows the result for the detailed examination on the heating process. In the drawing, “substrate heating H1/H2” means the heating temperature upon forming TiAl and the heating temperature at the surface of TiAl after formation, respectively. In the specimen E, like the specimen B, a substrate was heated under the condition of 270° C.×10 min before forming TiAl (the scale on the ordinate is different from that in FIG. 2). Specimen F was prepared by forming TiAl without heating the substrate, then heating the surface of TiAl under the condition of 270° C.×10 min, then laminating the underlayer and the magnetic layer successively. As in the specimen A shown in FIG. 2, when all of the layers were formed at a room temperature, diffraction peaks for (110) in the underlayer and for (00.2) and (10.1) in the magnetic layer were obtained, to exhibit typical random orientation in the in-plane recording medium. For the reference, in the case of film formation at a room temperature, similar orientation is obtained also in the Ni—P plated Al alloy substrate. That is, unless the substrate is heated at least to 150° C. or higher upon forming the underlayer (according to the result of our study), the underlayer does not orient in (100) direction.

On the other hand, in the specimen B preferred orientation was obtained for the underlayer and the magnetic layer, but no diffraction peak attributable to TiAl was not observed. Then, it was examined whether the substrate temperature upon forming TiAl had an important roll or not for obtaining favorable orientation in the underlayer and the magnetic layer. As described previously, the specimen F was prepared by forming the TiAl seed layer at a room temperature and then heating the surface to 270° C. to form an underlayer and a magnetic layer. In the specimen F, diffractions peak attributable to (110) orientation of the CrMo underlayer and (00.2) orientation of the magnetic layer were obtained (not separably) and the axis of easy magnetization could not be oriented within the plane of film. That is, it has been found that formation of TiAl at the room temperature is not preferred in view of the control for the crystallographic orientation of the underlayer and the magnetic layer. According to a further detailed study, it has been found that the temperature for forming TiAl should at least be 100° C. or higher. On the other hand, the upper limit for the temperature forming TiAl does not exceed 400° C. as shown in FIG. 2 More specifically, temperature of 380° C. or lower is preferred in view of the orientation of the axis of easy magnetization within the plane of film.

The specimen G was formed by heating a substrate under the condition of 270° C.×10 before forming TiAl, heating the surface of TiAl under the condition of 270° C.×10 min after forming TiAl and successively laminating the underlayer and the magnetic layer. Compared with the specimen E, the specimen G exhibited that the intensity of diffraction peaks for (200) in the underlayer and for (11.0) in the magnetic layer was increased remarkably and orientation of the axis of easy magnetization within the plane of film was improved. From the result, it can be seen that the two step heating for the substrate and the TiAl surface improves the orientation within the plane of film.

Orientation for (100) in the underlayer and for (11.0) in the magnetic layer was improved by heating the surface of TiAl and the direct reason therefor is that the TiAl surface was oxidized. However, as shown for the specimen F, no satisfactory orientation could be obtained even when the surface of the TiAl formed at a room temperature was heated, namely, the surface was oxidized. It is important to oxidize the surface of the TiAl seed layer formed by heating the substrate to about 100° C. or higher and 380° C. or lower. The example described above shows a method of forming the TiAl seed layer and then introducing the heating process as a means for oxidizing the surface of TiAl. However, as an alternative method, the oxidizing treatment can be applied for the surface of TiAl also by forming the TiAl seed layer and then exposing the surface to an oxygen atmosphere. As a concrete means, it is practical to introduce an oxygen gas in the processing chamber. Then, a study was conducted on the oxidizing treatment for the surface of TiAl by forming the TiAl seed layer and then introducing an oxygen gas into the chamber. The amount of the oxygen gas introduced was varied such that the pressure in the processing chamber formed an atmosphere of 0.13, 0.27, 0.67, 1.33 Pa. As a result, it was confirmed that when the oxygen gas was introduced such that the pressure in the chamber was at 0.27 Pa or higher, favorable orientation was obtained for the underlayer and the magnetic layer and the axis of easy magnetization was strongly orientated within the plane of film.

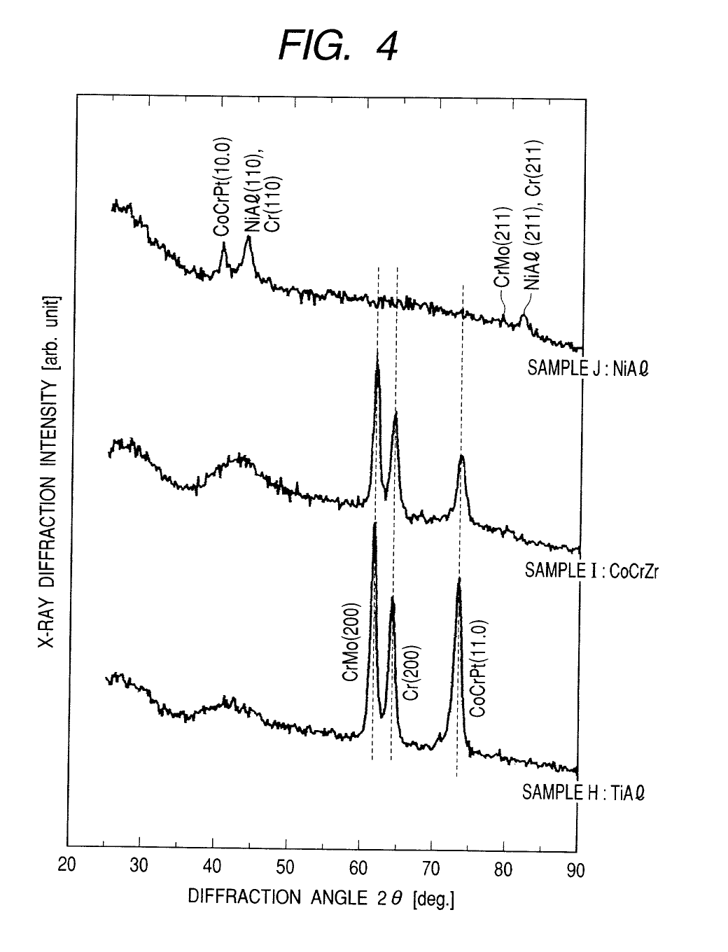

FIG. 4 shows X-ray profiles of media using the TiAl seed layer according to this invention, and Co-30 at % Cr-10 at % Zr and Ni-50 at % Al seed layers as the existent media. The medium using the TiAl seed layer (specimen H) was prepared with the same layer constitution and by the same process (including two step heating) as those in the specimen G. On the other hand, media using the seed layers of CoCrZr (specimen I) and NiAl (specimen J) were prepared by forming each seed layer to 100 nm on a substrate, forming a dual layered underlayer comprising Cr (20 nm) and C-30 at % Mo (20 nm) thereon and forming Co-20 at % Cr-10 at % Pt (20 nm) as the magnetic layer. The layer constitution after the Cr underlayer was identical with that of the medium using the TiAl seed layer. However, in the medium using the existent seed layer, only the substrate was heated under the condition of 270° C.×10 min without applying the heating process after forming the seed layer.

When comparing the media of TiAl and CoCrZr seed layers, the diffraction intensity for (200) in the underlayer and for (11.0) in the magnetic layer is larger in the medium using TiAl. That is, it can be seen that the crystallographic orientation of the axis of easy magnetization within the plane of film is strong and preferred crystal growing is obtained as the in-plane recording medium in a case of using TiAl as the seed layer. When the magnetic crystal grains of the media were examined by using TEM, the average magnetic crystal grain was 10 nm in the case of using the TiAl seed layer and 15 nm in the case of the CoCrZr seed layer. For reducing the medium noises, smaller crystal grain size is preferred and it has been found that the TiAl seed layer is more excellent. On the other hand, as the countermeasure for the thermal fluctuation resistance, it is desirable that the dispersion of the crystal grain size of the magnetic layer is smaller. It is 25% in the TiAl seed layer and 35% in the CoCrZr seed layer. It has been found that the TiAl seed layer is more excellent also in this regard.

Then, when TiAl and NiAl are compared, the preferred orientation plane is different between the underlayer and the magnetic layer. The NiAl seed layer is of a crystalline film and since the NiAl film is oriented to (211) direction, hetero-epitaxial growing is conducted for (211) in the underlayer and for (10.0) in the magnetic layer. (10.0) in the magnetic layer, like that (11.0), is the orientation in which the axis of easy magnetization is directed within the plane of film. When the diffraction intensity for (11.0) in the magnetic layer of the TiAl medium is compared with the diffraction intensity (10.0) in the magnetic layer in the NiAl medium, the intensity is larger in the TiAl medium. However, since the sensitivity of the diffraction intensity at the lattice plane to X-ray is different depending on the plane, it should not be compared directly. The sensitivity depending on each lattice plane is shown by the structure factor, which is 20 for (10.0) and 80 for (11.0) in the bulk Co. That is, the sensitivity of the (10.0) component is ¼ of the (11.0) component. When they were compared again taking this into consideration, it was also found that the diffraction intensity for (11.0) in the magnetic layer of the medium using TiAl was larger than the diffraction intensity for (10.0) in the magnetic layer of the medium using NiAl. Further, when the lattice image of the magnetic layer was observed by TEM, the number of grains for which the lattice fringe corresponding to the c face was extremely small in the medium using NiAl, and this supports the result obtained by X-ray analysis.

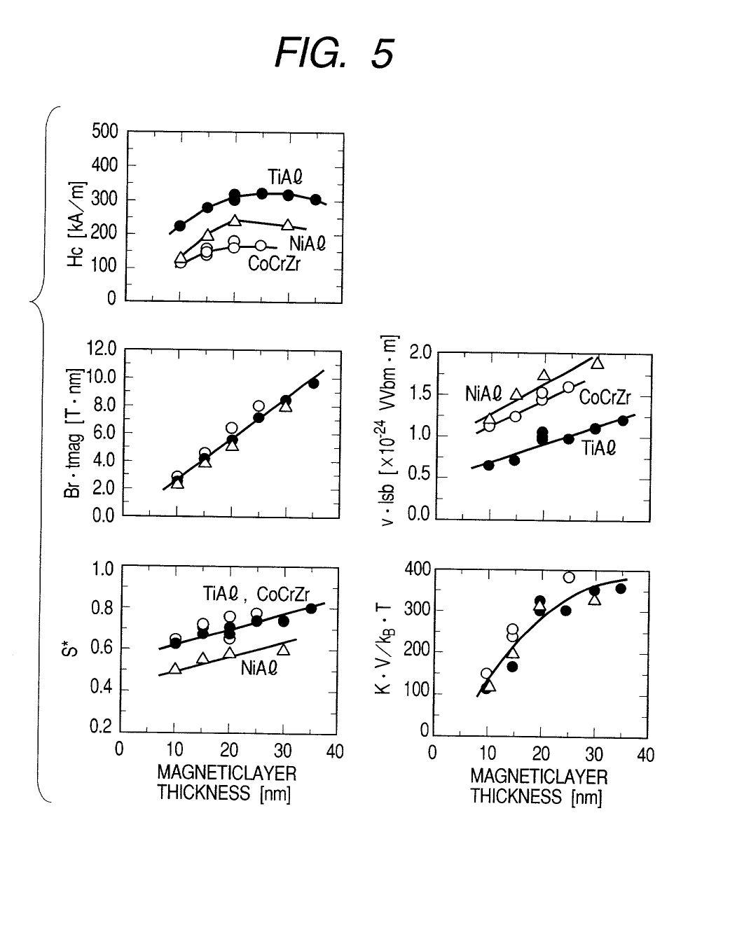

FIG. 5 shows the result of preparing specimens while changing the thickness of the magnetic layer as the media using TiAl, CoCrZr and NiAl seed layers and comparing the magnetic characteristics. The coercivity (Hc) increases along with the thickness of the magnetic layer in the media using any of the seed layers but the medium using TiAl shows the highest value in a range for all of the layer thickness. Since higher coercivity is more suitable to high density recording, the superiority of the medium using the TiAl seed layer according to this invention has been demonstrated. The coercivity squareness (S*) is smaller only for the NiAl layer compared with other two seed layer media. Furthermore, also with regard to the product of the residual magnetic flux density and the magnetic layer thickness (Br·tmag), it can be seen by closer observation that the value for the NiAl medium is smallest. This is attributable to that the in-plane orientation of the axis of easy magnetization is worst in the NiAl medium.

In the in-plane recording medium, it is preferred that the axis of easy magnetization is oriented within the plane of film since recording by a recording head is easy and the resolution is improved. When R/W evaluation was conducted actually, resolution was highest in the TiAl medium. On the other hand, if the in-plane orientation of the axis of easy magnetization was poor as in the NiAl medium, a large load was imposed on the recording head and no sufficient overwriting characteristics were obtained. When compared with the TiAl medium, the NiAl medium was poor as much as by 6 dB irrespective of lower coercivity. For coping with the increasing density in the future, the medium coercivity tends to be increased but the NiAl medium is not so preferred since it most increases the burden on the reading head. The activation magnetic moment (v·Isb) has a close concern with the magnitude of the medium noises. It has been reported that the medium noises are reduced more as the activation magnetic moment is smaller.

The medium using the TiAl seed layer shows the smallest value of the activation magnetic moment. When R/W evaluation (recording density: 350 kFCI) was conducted actually, it was confirmed that the medium using the TiAl seed layer showed the lowest noises (lower by 10 to 25%) and the noises tended to be reduced as the activation magnetic moment was smaller. K·V/k_{B}·T shows the thermal fluctuation resistance and it is required that the value is at least 100 or more. In this regard, all the media can satisfy the specification.

### Example 2

The medium prepared in accordance with this example is to be explained with reference to FIG. 1. On a glass substrate 10 of 65 mmφ in outer diameter, TiAl seed layers 11, 11′ (20 nm) were formed. Then, Cr-20 at % Ti underlayers 12, 12′ (20 nm) were formed, and Co system alloy magnetic layers 13, 13′ (13 nm) were disposed. Finally, protective layers 14, 14′ each comprising C were formed and lubricants were coated to manufacture a magnetic recording medium of this example. In this example, all of the layers were prepared by a DC magnetron sputtering method. Basic sputtering conditions were at an Ar gas pressure of 0.27 Pa and an input power density of 39.5 kW/m².

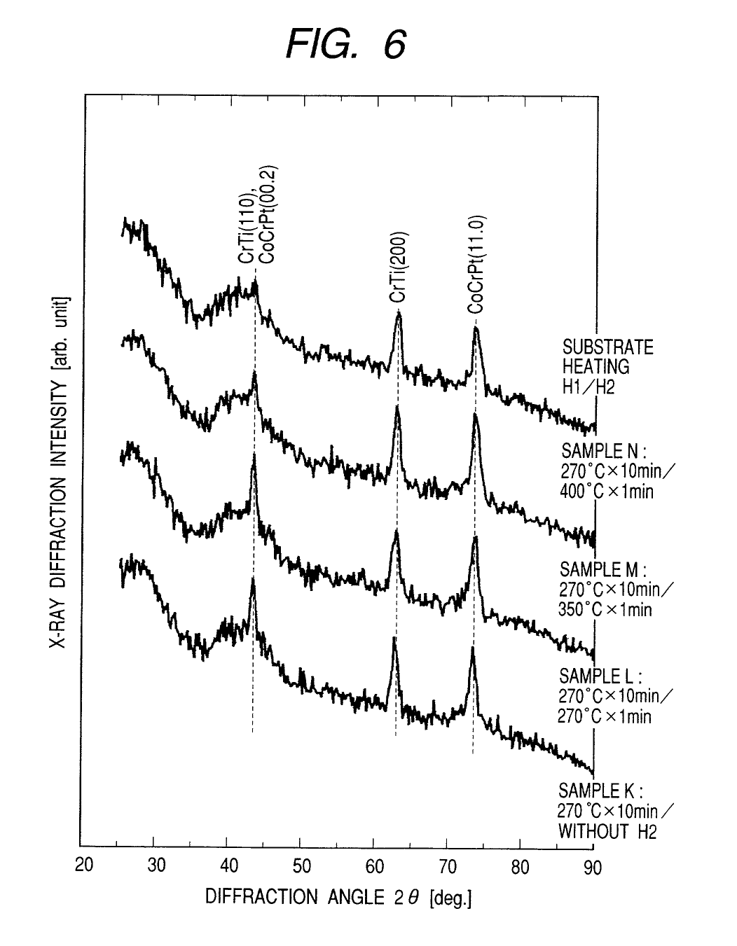

FIG. 6 shows the change of X-ray profiles when using Co-20 at % Cr-10 at % Pt (14 nm) for the magnetic layer and changing the heating conditions for TiAl under the substrate heating conditions of 270° C.×10 min. TiAl was not heated for the specimen K and the heating temperature for TiAl was set to 270, 350 and 400° C., respectively, for the specimens L, M and N. TiAl was heated for the time of 1 min. It can be seen that the diffraction intensity for (110) in the CrTi underlayer or for (002) in the CoCrPt magnetic layer is reduced along with increase for the heating temperature of TiAl. Two factors may be considered for the reason. At first, the oxidizing reaction on the surface of TiAl was promoted by rising the heating temperature. Secondly, the temperature upon forming the underlayer was increased. As described above, while the underlayer having the b.c.c. crystal structure tends to be oriented to (110.) direction as the closed-packed face in the state where energy (substrate temperature) is low, the preferred orientation face changes to (100) as the energy increases.

From the foregoing results, it has been found that the TiAl seed layer according to this invention functions effectively even in a case of using a single alloy underlayer and the axis of easy magnetization can be oriented within the plane of film. The medium noises, are further reduced in the medium using the CrTi underlayer compared with the case of using the dual CrMo/Cr underlayer shown in Example 1. This is attributable to that the crystal grain size of the CrTi underlayer is small. However, when the CrTi underlayer is used, since the thermal fluctuation resistance is somewhat deteriorated due to the reduction in the grain size when using the CrTi underlayer, it is necessary to selectively use the underlayer depending on whether the preference is attached to the reduction of noise or resistance to thermal fluctuation.

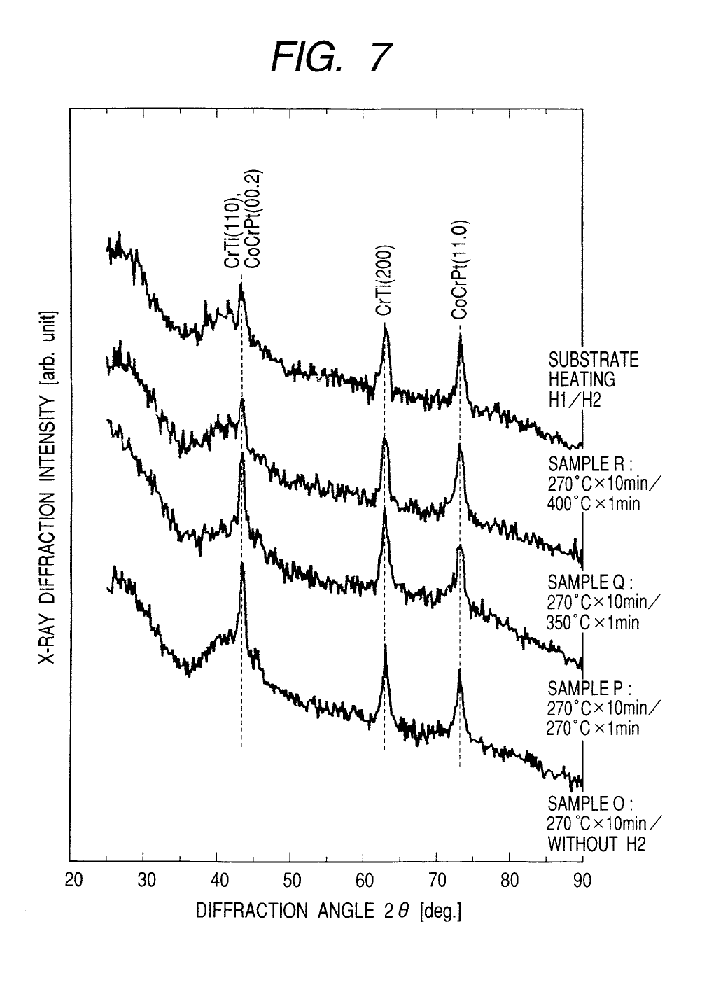

Then, FIG. 7 shows a result of conducting the same study as that in FIG. 6 while using Co-23 at % Cr-14 at % Pt (14 nm) for the magnetic layer. It can be seen that the crystallographic orientation of the axis of easy magnetization within the plane increases by increasing the heating temperature for TiAl also in a case of increasing the Cr, Pt concentration in the magnetic layer. However, the diffraction intensity for (110) in the CrTi layer or for (00.2) CoCrPt layer increases when compared with FIG. 6. That is, the vertical component of the axis of easy magnetization increases. This is considered to be attributable to the following reasons. Generally, Cr in the magnetic layer segregates to the grain boundary. When the Cr concentration in the magnetic layer increases, the amount of Cr discharged to the boundary between the underlayer and the magnetic layer also increases. Accordingly, it is considered that hetero-epitaxial growing between the underlayer and the magnetic layer is inhibited and the vertical component of the axis of easy magnetization increases. Since this phenomenon is conspicuous in a case of using the CrTi underlayer, this problem can be solved to some extent by using the underlayer such as of CrMo, CrW, CrTa (alloy underlayer comprising b.c.c. and b.c.c.). Even when the material for the underlayer is optimized, it is necessary that the Cr concentration in the magnetic layer adjacent with the underlayer is reduced to at least 25 at % or less.

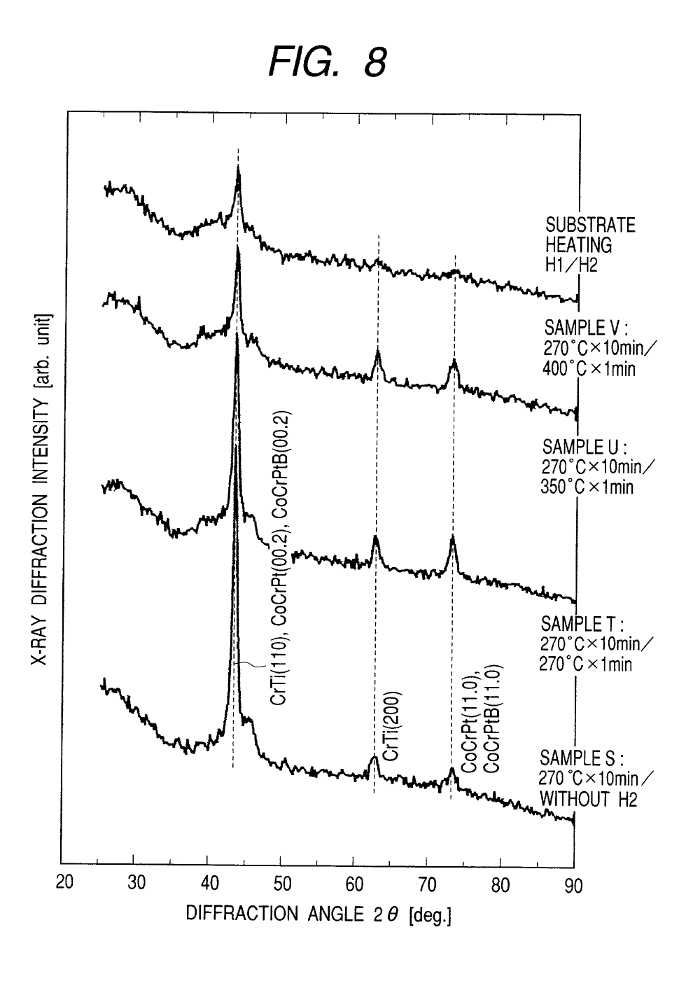

Finally, FIG. 8 shows a result concerning the dual underlayer by using Cr-20 at % Ti (10 nm) as the underlayer on which a first magnetic layer comprising Co-23 at % Cr-14 at % Pt (7 nm) is formed and, further, a second magnetic layer comprising cobalt Co-21 at % Cr-14 at % Pt-5 at % B (7 nm) is formed. Also in the case of the dual magnetic layer, the diffraction intensity decreases for (110) in the CrTi layer, for (00.2) in the CoCrPt layer and for (00.2) in the CoCrPtB layer along with rising of the heating temperature for TiAl and it can be seen that axis of easy magnetization is oriented within the plane. On the other hand, (00.2) component of the magnetic layer is further strengthened compared with FIG. 7, because the Cr segregation in the magnetic layer is promoted when B is added to the magnetic layer. In the medium of this example, the (200) component in the underlayer and the (11.0) component in the magnetic layer are relatively weakened compared with FIG. 6 or FIG. 7, because the thickness of the underlayer was reduced. The diffraction intensity is weak particularly in the specimen heated at 400° C. and lattice fringe corresponding to the C face could be observed in most magnetic grains upon conducting lattice image observation by TEM. Further, also in electron-beam diffraction images, it was shown that the c axis of the magnetic layer having the h.c.p. structure was oriented within the plane also in the electron-beam diffraction images.

In the profile of X-ray diffraction, even when the peak intensity corresponding to (00.2) in the magnetic layer was somewhat strong, satisfactory values could be obtained for the R/W characteristics, namely, the medium noises and the resolution providing that diffraction corresponding to (11.0) was obtained. However, no satisfactory R/W characteristics could be obtained for such specimens that in-plane orientation of the axis of easy magnetization could not be confirmed by TEM.

### Example 3

In this example, change of the medium characteristics was examined in a case of varying the compositional ratio of the TiAl seed layer. The medium prepared in this example is to be explained with reference to FIG. 1. On a glass substrate 10 of 65 mmφ in outer diameter, TiAl seed layers 11, 11′ (20 nm) were formed. Then, dual underlayers 12, 12′ each comprising a first underlayer of Cr-20 at % (15 nm) and a second underlayer of Cr-30 at % Mo (5 nm) were formed, and a magnetic layers 13, 13′ of Co-21 at % Cr-16 at % Cr-16 at % Pt-5 at % Ta (15 nm) were disposed. Finally, protective layers 14, 14′ comprising C were formed and lubricants were coated to prepare a magnetic recording medium of this example. In this example, all of the layers were prepared by a DC magnetron sputtering method. Basic sputtering conditions were at an Ar gas pressure of 0.27 Pa and an input power density of 39.5 Kw/m². The substrate heating condition was at 270° C.×10 min. Further, after forming the TiAl seed layer, an oxygen gas was introduced at a flow rate of 100 sccm into the processing chamber and the pressure in the chamber was reduced to 0.4 Pa to conduct oxidation for the TiAl surface.

Table 1 shows the result of examining the in-plane crystallographic orientation of the axis of easy magnetization when the compositional range for Ti and Al of the TiAl seed layer was varied. The in-plane crystallographic orientation was evaluated in accordance with (11.0) peak intensity in the CoCrPtTa layer in the X-ray diffraction profile, and this was evaluated as “◯” where the peak intensity for (11.0) was 2.5 times or more of the average noise level value in the X-ray diffraction profile, as “Δ” where it was less than 2.5 time and “×” where no peak was observed. It can be seen from the table that the Ti component in the seed layer has to be 35 at % or more and 65 at % or less and the Al component is 35 at % or more and 65 at % or less. Within the region of the composition, the diffraction peak attributable to the seed layer was not recognized or weak and it is considered that the crystals of the seed layer comprise micro crystals with the grain size of 10 nm or less or amorphous. On the other hand, in a case where the composition of the seed layer was 30 at % Ti-70 at % Al and 70 at % Ti-30 at % Al, diffraction peaks attributable to the crystallization of the seed layer were observed and it is considered that they worsened the crystallographic orientation in the underlayer and the magnetic layer.

TABLE 1

| | | Crystallographic |
|---|---|---|
| Ti component [at %] | Al component [at %] | orientation |
| 30 | 70 | x |
| 35 | 65 | Δ |
| 40 | 60 | |
| 48 | 52 | ∘ |
| 50 | 50 | ∘ |
| 60 | 40 | ∘ |
| 65 | 35 | Δ |
| 70 | 30 | x |

Then, the composition for the magnetic layer was examined. In the same medium composition as that in the example described above, Ti-52 at % Al (15 nm) was used for the seed layer. The magnetic layer used had a dual layered structure comprising a first magnetic layer of Co-24 at % Cr-14 at % Pt (7 nm) and a second magnetic layer of Co-20 at % Cr-16 at % Pt-x at % B (7 nm). x at % for the concentration of B in the second magnetic layer means that the concentration for B was varied. Table 2 shows the result of the study of the in-plane crystallographic orientation of the axis of easy magnetization. Evaluation standards “◯”, “Δ”, “×” in the table are as described above. It can be seen from the table that it is a necessary condition for the concentration of B to be 8 at % or less in order to improve the in-plane crystallographic orientation of the axis of easy magnetization. Further, a similar trend is also obtained in a case of using at least one element selected from C, Si and Ta instead of B.

TABLE 2

| | Crystallographic |
|---|---|
| B component [at %] | orientation |
| 0 | ∘ |
| 2 | |
| 4 | ∘ |
| 6 | ∘ |
| 8 | ∘ |
| | Δ |
| 10 | x |

(Increment of B equals to decrease of Co)

As described above, the concentration of the additive element is preferably 0.5 at % or more and 8 at % or less in order to attain reduced noises and high coercivity and, further, it is at least necessary that Co is 56 at % or more in order to prevent non-magnetization of the magnetic layer.

Similar effect was obtained also by introducing a nitrogen gas instead of the oxygen gas after forming the TiAl seed layer.

### Example 4

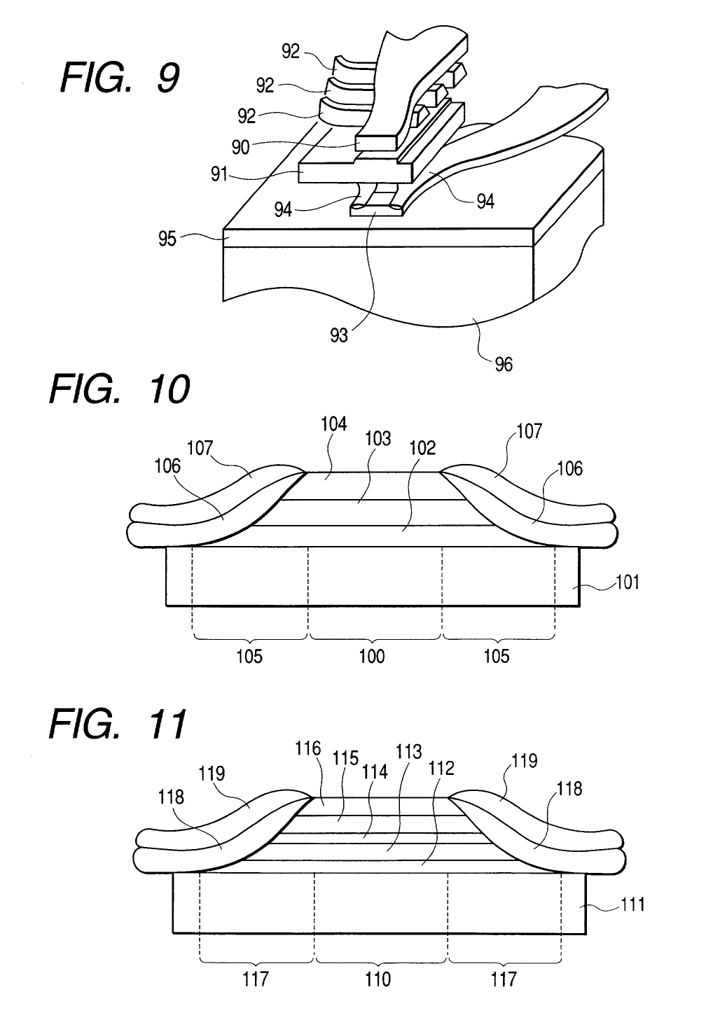

The performance of the magnetic recording media of the examples described above can be utilized fully by using a magnetic head having a read only sensor utilizing the magnetoresistive effect as exemplified in FIG. 9.

A recording magnetic head was an induction type thin film magnetic head comprising a pair of recording magnetic poles 90, 91, and coils 92 intersecting magnetically therewith in which the thickness of a gap layer between the recording magnetic poles was 0.25 μm. Further, the magnetic pole 91 was paired with a magnetic shield layer 95 of 1 μm thickness, which served also as a magnetic shield for the reading magnetic head, and the distance between the shield layers was 0.2 μm. The read only magnetic head was a magnetoresistive head comprising a magnetoresistive sensor 93 and a conductor 94 as an electrode. The magnetic head was disposed on a magnetic head slider substrate 96. In FIG. 9, the gap layer between the recording magnetic poles, and the gap layer between the shield layer and the magnetoresistive sensor are not illustrated.

FIG. 10 shows a detailed cross sectional structure of the magnetoresistive sensor 93. A signal sensing region 100 of the magnetic sensor was comprised of a portion in which a lateral bias layer 102, a separation layer 103 and a magnetoresistive ferromagnetic layer 104 were formed successively on an Al oxide gap layer 101. An NiFe alloy of 20 nm thickness was used for the magnetoresistive ferromagnetic layer 104. NiFeNb of 25 nm thickness was used for the lateral bias layer 102, but it may be also a ferromagnetic alloy of relatively high electric resistance and with good soft magnetic property such as NeFeRh. The lateral bias layer 102 is magnetized by a magnetic field formed by a sense current flowing through the magnetoresistive ferromagnetic layer 104 in the direction within the plane of film perpendicular to the current (lateral direction), to apply a lateral bias magnetic field to the magnetoresistive ferroelectric layer 104. This provides a magnetic sensor capable of obtaining a linear read output relative to the leakage field from the medium. Ta of 5 nm thickness of a relatively high electric resistance was used for the separation layer 103 for preventing the shunt of the sense current from the magnetoresistive ferromagnetic layer 104. The signal sensing region 100 has tapered portions 105 on both ends thereof each fabricated into a tapered shape. The tapered portion 105 comprises a permanent layer 106 for making the magnetoresistive ferromagnetic layer 104 into a unitary magnetic domain and a pair of electrodes 107 formed thereon for taking out signals. It is important that the permanent magnet layer 106 has high coercivity and does not easily change the magnetization direction, for which CoCr, CoCrPt alloy or the like is used.

Further, as the magnetoresistive sensor 93, use of a spin valve type as shown in FIG. 11 is preferred since a larger output can be obtained. The signal sensing region 110 of the magnetic sensor has a structure in which 5 nm Ta buffer layer 112, 7 nm first magnetic layer 113, 1.5 nm Cu intermediate layer 114, 3 nm second magnetic layer 115, and 10 nm Fe-50 at % Mn antiferromagnetic alloy layer 116 are formed successively, an Ni-20 at % Fe alloy was for the first magnetic layer 113 and Co was used for the second magnetic layer 115. The magnetization of the second magnetic layer 115 is fixed in one direction by the exchange magnetic field from the antiferromagnetic alloy layer 116. On the contrary, the magnetization direction of the first magnetic layer 113 in contact with the second magnetic layer 115 by way of the non-magnetic intermediate layer 114 changes depending on the leaked field from the magnetic recording medium. Resistance of the entire three layers changes depending on the change in the relative direction of the magnetization in the two magnetic layers. This phenomenon is referred to as a spin valve effect and a spin valve type magnetic head utilizing this effect was used for the magnetoresistive sensor in this example. Further, the tapered portion 117 comprising the permanent layer 118 and the electrode 119 is identical with that of the usual magnetoresistive sensor shown in FIG. 10. Further, use of the magnetoresistive element utilizing the tunnel effect (TMR device) as the magnetoresistive sensor 93 is preferred for attaining high output.

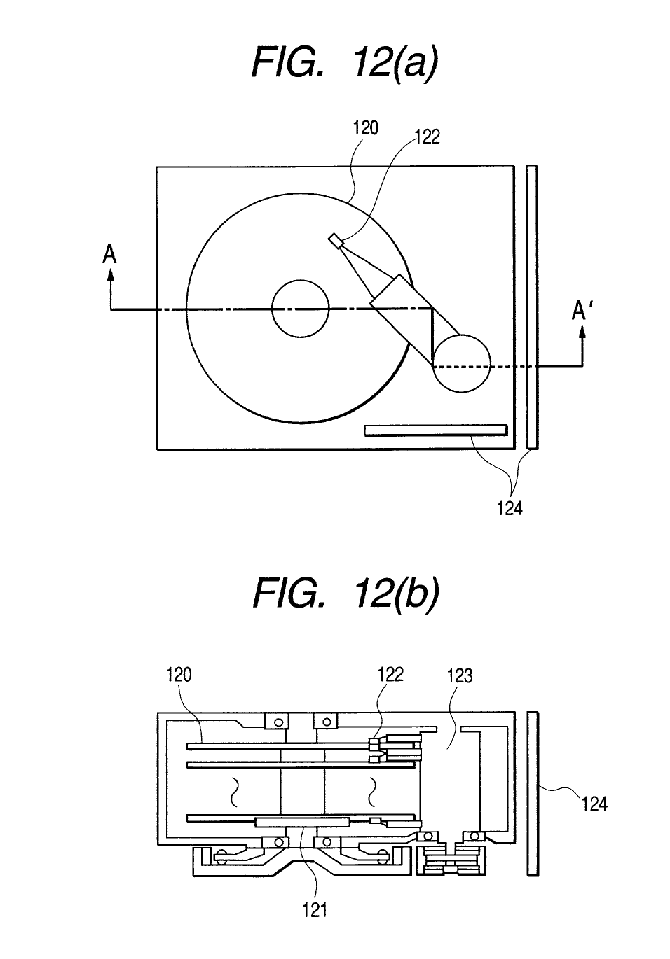

An example of the magnetic recording apparatus is shown schematically in FIG. 12(a) for the upper view and in FIG. 12(b) for the cross sectional view taken along line A-A′.

A magnetic recording medium 120 is held by a holder connected with an in-plane magnetic recording medium driver 121, and the magnetic head 122 schematically shown in FIG. 9 is disposed being opposed to each surface of the magnetic recording medium.

The magnetic head 122 is raised stably at a low flying height of 0.05 μm or less and driven to a desired track at a head positioning accuracy of 0.5 μm or less by a magnetic head driver 123. Signals reproduced by the magnetic head 122 are put to waveform processing by a read/write signal processing system 124. The read/write signal processing system 124 comprises an amplifier, an analog equalizer, an AD converter, a digital equalizer, a maximum likelihood decoder, etc. The reproduced waveforms from the head utilizing the magnetoresistive effect may sometime be read erroneously as signals different from recorded signals because of the asymmetricity for the levels of positive and negative signals by the characteristics of the head or the effects of frequency characteristics of the recording/reproducing system. The analog equalizer has a function of shaping the reproduced waveforms and amending such errors. The amended waveforms are digitalized through the AD converter and further waveform-shaped by the digital equalizer. Finally, the amended signals are decoded by the maximum likelihood decoder into most plausible data. With the reproduced signal processing system of the constitution described above, signals are recorded and reproduced at an extremely low error rate. Further, existent equalizer or maximum likelihood decoder may be used.

With the structure of the apparatus described above, it can cope with high density of 10 Gbits or more per one square inch and a high density magnetic recording apparatus having a recording capacity three times as large as the existent magnetic recording apparatus has been obtained. Further, in a case of saving the maximum likelihood decoder from the recording/reproducing signal processing system and replacing the same with an existent waveform discrimination circuit, a magnetic recording apparatus having a storage capacity twice as large as the existent apparatus has be attained.

In the examples describe above, descriptions have been made to an example of a disk-like magnetic recording medium and a magnetic recording apparatus using the same, but it will be apparent that this invention is applicable also to tape or card type magnetic recording media having a magnetic layer only on one side, as well as a magnetic recording apparatus using such magnetic recording media. Further, the method of manufacturing the magnetic recording media is not restricted only to the DC magnetron sputtering method but any other means may also be used such as an ECR sputtering method, ion beam sputtering method, vacuum vapor deposition method, plasma CVD method, coating method or plating method.

In the magnetic recording medium according to this invention in which a cobalt Co alloy magnetic layer is formed by way of an underlayer comprising Cr or Cr alloy on a substrate, a seed layer containing at least Ti and Al is disposed between the substrate and the underlayer, the magnetic layer has an h.c.p. structure which is grown in parallel with the substrate in (11.0) direction. In this case, the seed layer preferably contains at least 35 at % or more and 65 at % or less of Ti and 35 at % or more and 65 at % or less of Al, by which a medium having high coercivity, reduced noises and with less effect of thermal fluctuation can be obtained. Further, combination of the magnetic recording medium with a magnetic head having a read only device utilizing the magnetoresistive effect can provide a magnetic recording apparatus having a recording density of 10 Gbits or more per one square.

1. A magnetic recording medium comprising a non-magnetic substrate, an amorphous or micro crystal seed layer at least containing Ti and Al formed on the non-magnetic substrate, a magnetic layer containing a Co alloy, and an underlayer formed between the seed layer and the magnetic layer containing the Co alloy.

2. A magnetic recording medium comprising a non-magnetic substrate, an amorphous or micro crystal seed layer at least containing Ti and Al formed on the non-magnetic substrate, an underlayer containing Cr or Cr alloy and a magnetic layer containing a Co alloy formed on the underlayer.

3. A magnetic recording medium as defined in claim 1, wherein the seed layer contains at least 35 at % or more and 65 at % or less of Ti, and at least 35 at % or more and 65 at % or less of Al based on the entire composition.

4. A magnetic recording medium as defined in claim 1, wherein the underlayer comprises a multi-layered structure having at least two layers, the underlayer of the multi-layered structure comprises a first underlayer containing Cr or CrTi and a second underlayer containing at least one element selected from Cr, Nb, Mo, Ta, W and Ti, formed successively from the side nearer to the substrate.

5. A magnetic recording medium as defined in claim 1, wherein one or plurality of underlayers are formed on the seed layer, and a CoCr alloy system magnetic layer containing 0.5 at % or more and 8.0 at % or less of at least one element selected from C, B, Si and Ta is formed on the underlayer.

6. A magnetic recording medium as defined in claim 5, wherein one or a plurality of intermediate layers containing at least Co and Cr are formed on one or a plurality of underlayers, a CoCr alloy system magnetic layer containing 0.5 at % or more and 8.0 at % or less of at least one element selected from C, B, Si and Ta is formed on one or a plurality of the underlayers.

7. A magnetic recording medium as defined in any one of claims 1 to 5, wherein the magnetic layer has an h.c.p structure and is oriented in (11.0) direction relative to the plane parallel with the substrate.

8. A magnetic recording apparatus including a magnetic recording medium having an amorphous or micro crystal seed layer containing Ti and Al, a driver for driving the magnetic recording medium in the recording direction, a magnetic head having a reproducing section and a recording section containing a magnetoresistive sensor, a device for moving the magnetic head relative to the magnetic recording medium and a read/write signal processing unit for conducting waveform processing to input signals and output signals to and from the magnetic head.

9. A magnetic recording apparatus as defined in claim 7, wherein the magnetoresistive sensor is a spin valve type magnetoresistive sensor.

10. A magnetic recording apparatus as defined in claim 7, wherein the magnetoresistive sensor is a tunnel effect type magnetoresistive sensor.

11. A method of manufacturing a magnetic recording medium including a process of forming a seed layer containing at least Ti and Al on a substrate and conducting an oxidizing or nitriding treatment to the seed layer after forming the seed layer.
